(19) United States
(12) Patent Application Publication
(10) Pub. No.: US 2014/0089161 A1
(43) Pub. Date: Mar. 27, 2014

(54) Method and Apparatus for Simultaneous Average Price Execution in Leader and Follower Trading Accounts

(71) Applicants: Joel Robbins, Riverwoods, IL (US); David Widerhorn, Chicago, IL (US)

(72) Inventors: Joel Robbins, Riverwoods, IL (US); David Widerhorn, Chicago, IL (US)

(73) Assignees: DAVID WIDERHORN CONSULTING, LLC, Chicago, IL (US); ROBBINS FINANCIAL GROUP, LTD., Chicago, IL (US)

(21) Appl. No.: 14/032,857

(22) Filed: Sep. 20, 2013

Related U.S. Application Data
(60) Provisional application No. 61/704,307, filed on Sep. 21, 2012.

(51) Int. Cl. G06Q 40/04

(52) U.S. Cl. CPC G06Q 40/04
USPC 705/37

(57) ABSTRACT

A system, method and apparatus is disclosed for single, block-trade fulfillment and execution of leader and follower trade orders for financial products. The system and method includes an order routing means that aggregates a lead trader's trade order and the pre-registered order instructions of one or more follower traders, and that then fills the aggregated orders as a single block trade at one single price. The system and method also includes means to segregate identifying information about the lead trader and the follower traders from each other, and to re-integrate that identifying information in reports that are sent back to individual leader and follower traders. Further, the system and method includes storage means to store and record all trading information for regulatory audit purposes.

### CROSS-REFERENCE TO RELATED APPLICATIONS

This application is submitted pursuant to 35 USC §119(e) and claims the benefit of the earlier-filed provisional application Ser. No. 61/704,307, filed on Sep. 21, 2012.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention is in the technical field of computer-implemented business methods and financial instruments, and computing machines and apparatus that are utilized to implement those business methods. More particularly, the present invention is in the technical field of creating and managing investment portfolios, and describes a novel method of administering investment rules and strategies via computing machine-managed techniques.

Prior art trading technologies allow futures, forex, and stock and option investors to set up automatic trade orders as a function of the actual trading activity of an advisor or “lead trader.” These technologies direct a computing machine to monitor when an order is placed by a lead trader, which order can be filled at any exchange or dealer, and subsequently to place a block order that mirrors the lead trader's order for a group of followers. That following order may be a “market” order, stop-loss, or any other common, customized, or hybrid form of order. For example, a lead trader may place a buy order for 10,000 shares of a particular stock, which order will be filled at a specific price, say $10 per share. Prior art technologies that detect this order may then direct a “follower” order for a group of followers. Where the group of followers is large, the “follower” order may be significantly larger than the lead order. In the above example, the “follower” order may be a buy order for 250,000 shares, particularly if the lead trader has accumulated a large group of followers. Implementation of a large buy order will drive up the per-share price of the stock, thus creating a significant price differential between the lead trader's fill price and the average price realized within the follower block due to the time lag between electronic confirmation of the lead account fill and execution of the follower block. Price averaging may reduce the disparity between the lead order and the follower block order. That is, the 250,000 share follower block may be filled at various price points between $10 and $12 per share, but the prior art might facilitate a weighted average of $10.80 per share for the aggregate 250,000-share follower block

Current electronic trading technology can provide near-instantaneous confirmation of the lead account trade with rapid execution of the followers' block trade. The speed at which these trades will be implemented in theory should minimize price differences for trades made by followers' accounts. That is, the lead account trade can be made and confirmed and in theory the follower accounts can order and execute their trades and even an entire block trade within a sufficiently short period of time after the lead account trade execution to minimize or eliminate the effect that an influx of trading orders will have on the pricing of the underlying investment product. In practice, however, the same technology that facilitates this near-instantaneous trade confirmation also allows for near-instantaneous price adjustments in the underlying product and the follower accounts, regardless of how quickly the orders are placed. The follower account trades, whether done as a single block or in several trades, inevitably are executed with less favorable pricing as a result of the lead account trade. This is known as “slippage” and is highly detrimental to the success of follow-the-leader trading programs.

This follow-the-leader trading strategy arose largely as an alternative to mutual funds and other professionally-managed investment vehicles. Rather than purchase a mutual fund that is comprised of a bucket of stocks or other investment products that are selected by a professional investor or management group, or rather than paying an investment advisor to recommend and select stock and investment products, an individual trader will simply “latch on” to a professional investor, who is the lead trader, and replicate that lead trader's trading strategy. This is a hybrid form of “technical” trading, as opposed to substantive, research-based fundamental trading. The investor watches a specific investor, investment market, or investment product, and makes an investment move in lock-step with that investor, market or product regardless of the underlying fundamentals that may affect the value of the trade. With a pure technical trading strategy, for example, if the price of a particular stock or a market index is trending upward, the investor will simply buy into that market on the hope of riding the price wave increase. The investor in this example loses the benefit of the early increases in the market but gains the benefit of the latter upward price movement.

As noted, follow-the-leader traders can lose the benefit of early price movements if their trades are ordered and executed with too much time elapsing after the leader's trade is confirmed. In some cases, a delay of a few minutes or even seconds can adversely affect the value and profitability of a follower's trade. If the lead trader places a large order for a product that has a relatively low trading volume on any given day, basic principles of supply and demand will come into play such that the large order rapidly creates a demand for the product, thus increasing its price. The follower traders will want to have their orders placed as soon as is possible in this scenario; otherwise, they will pay a higher price for the same investment product.

This problem is enhanced when large numbers of follower traders place identical orders after a lead trader's order is executed or when follower trades are aggregated into a single block order. In this situation, the market will first absorb and react to the lead trader's order. If that lead order is significantly large in relation to the average trading volume of the underlying product, that order will materially affect the price of the product. Thereafter, multiple follower orders or large block orders that are placed for the same product will put additional and extensive price pressure on the product, thus further distorting the price of the product to the detriment of the followers' orders. In certain cases, a savvy lead trader, knowing that multiple followers are mimicking his trading strategy, can execute a buy order for a certain product, then watch the price of that product rise as all of the follower orders are placed and filled. This lead trader can immediately sell into this follower market and gain the benefit of the price increase wave that he or she created.

Existing trading gateways that facilitate leader and follower trading strategies may also expose account information and order requests of leaders and traders to each of those parties. This is expected, as follower traders in particular will want information regarding a leader's trades in order to place orders that mimic those trades. Regulatory and privacy concerns, however, will impinge upon the timely dissemination or publication of this type of information. As a result, an additional delay will occur within prior art follower and trader systems and strategies such that the followers will not have immediate access to a leader's trades. As noted above, this delay will frequently have an adverse impact on the pricing of the follower's trades.

It is therefore an object of the invention described herein to describe and define a system and methodology that can be utilized by follower traders to minimize or eliminate the effects of this slippage such that the followers' trade orders for investment products are placed and executed simultaneously with a lead trader's order.

It is a further an object of this invention to describe and define a system and methodology that eliminates the pricing pressure that may occur when a lead trader executes a trade for an investment product and several follower traders immediately thereafter place identical orders for that product.

It is yet another object of this invention to describe and define a system and apparatus that detects lead trader orders and automates follower trader orders simultaneously with the placement of the lead trader's order, such that the lead trader order and follower orders are part of a single block trade.

Still another object of the present invention is to provide an automated follower/leader trading system that shields the identities and account information of other parties from the individual parties who participate in the system.

These and other objects, features and elements of the system and methodology of this invention will become apparent to persons skilled in the art upon reviewing the following specification.

### SUMMARY OF THE INVENTION

The present invention is a method and system that allows multiple traders to follow a lead trader by executing a single transaction in a block containing both the leader and follower trading accounts and providing an average price system allocation that guarantees no slippage to all trading accounts. The software system combines each order entered by the lead trader with the follower block to create a single block. These block orders are entered either as market, stop or market-if-touched orders. Split fills are average-priced to provide a single fill price for leader and followers alike.

The present invention also includes a computing machine and apparatus that incorporates the afore-mentioned method and system into a tangible computer-based network that facilitates inputting of both lead trader and follower trader orders and that then accumulates and combines those orders prior to placement and execution, such that the market perceives the multiple orders to have been placed as a single block order. The system and method incorporated into the machine also facilitates and calculates price averages for split-fill orders to allow a single price to be allocated to the entire group of orders, including both leader and follower traders. Still further, it facilitates the setting and adjustment of allocations of the traded security among followers.

### BRIEF DESCRIPTION OF THE DRAWINGS

FIG. 1 is a block diagrammatic view of a trading system according to the present invention;

FIG. 2 is a block diagrammatic view of an alternative embodiment of a trading system according to the present invention;

FIG. 3a is a flow chart for trade execution for the system according to the present invention, showing order flow when a dedicated leader-follower software application is utilized to effect trading strategies;

FIG. 3b is a flow chart for trade execution for the system according to the present invention, showing order flow when a third-party trading software application is utilized to effect trading strategies;

FIG. 4 is a flow chart for trade execution for the system according to the present invention;

FIG. 5 is a data flowchart according to the present invention;

FIG. 6 is a detailed portion of a flow chart showing the steps of a specific transaction.

### DETAILED DESCRIPTION OF THE INVENTION

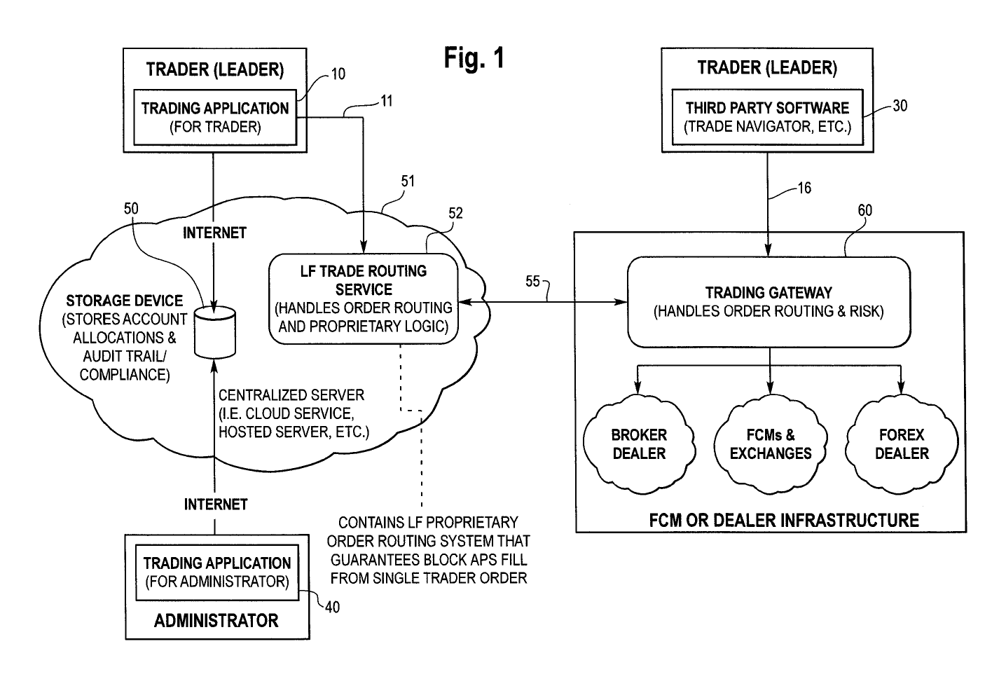

Referring now to the present invention in more details, in FIG. 1, a method for leader-trader execution trading is illustrated. The system provides for a front-end trading application 10 that enables a lead trader to order a trade. In one embodiment of this invention, the lead trader may also use commercially-available third-party software applications, such as Trade Navigator™, to feed the trading order into a front-end trading application 10 via a Financial Information eXchange (“FIX”) protocol compliant Application Programming Interface (“API”), which allows the third-party trading software to execute trades into the Leader/Follower system of the present invention. Persons skilled in the art and individual investors will understand the function and inner workings of such third-party software. It is not the intention of this invention to limit the invention to one specific third-party software system nor to necessarily include a third-party application 30 to interface with front-end trading application 10. Rather, the system, method and apparatus of the present invention can be configured to incorporate virtually any such third-party software or to enable leader/follower trading directly through front-end trading application 10.

The system, method and apparatus of the present invention provides an extensive front-end administrative tool 40 that allows leader/follower (“LF”) administrators to configure allocations, manage users and view compliance audit trails of all trading activity. Both the trader and an authorized LF administrator will have access to a data storage system 50. In one embodiment, the system provides for a centralized cloud storage system 51 that stores allocation and audit trail information as well as user-related settings in one global location. Such cloud-based storage systems are becoming increasingly common and in some sectors they are seen as the preferred technology over dedicated on-site data storage. The storage system 50 is depicted in FIG. 1 as a cloud-based storage methodology, but it is not the intent of the inventors to limit the data storage aspect of their invention to cloud storage. Rather, the system, method and apparatus of this invention includes and requires a data storage means, which is shown in FIG. 1 as a cloud-based storage methodology.

The system, method and apparatus of this invention includes a leader/follower trade routing means 52, which forwards data packets between the front-end trading application 10 or third-party trading application 30, the storage device 50, and the trading gateway 60, which ultimately administers and executes the trade orders. One or more data packets including trading orders and instructions will be sent from front-end application trading 10 along pathway 11 into router 52, which then directs a copy of those data packets to be stored in storage device 50 thus creating a stored record of the trading order. Router 52 will be programmed with proprietary logic that enables it to read the address information in the data packets to determine the ultimate destination of those packets. The router 52 thus performs a “traffic directing” function within the leader/follower system and method of this invention. In addition to directing a copy of the data packets to be stored in the storage device 50, router 52 also send those data packets into trading gateway 60, where the order will be filled and executed.

Also via its proprietary logic, router 52 confirms that data packets comprising all leader and follower trades are sent simultaneously into trading gateway 60, thus verifying that all orders are aggregated and filled as a single trade order. The proprietary logic that controls this function can be configured in a manner that is optimum for the administrator who establishes a leader/follower trading system according to the teaching of the present invention, and no specific form of logic is claimed or described in this specification. Persons skilled in the art will understand how to configure and code this logic. For example, router 52 may be configured to aggregate specific quantities of trading orders before sending the orders into gateway 60 for execution. Alternately, router 52 may be configured to hold an initial leader order for a specific number of computing cycles before sending the order into gateway 60, thus allowing follower orders to aggregate with the leader order.

A preferred embodiment of the present invention will include a dedicated router 52 into which proprietary logic has been encoded for this traffic-directing function. A scaled-back embodiment of this invention would insert this proprietary logic directly into front-end administrative tool 40 which would then connect with trading gateway 60 to order and execute trades. As can be seen in FIG. 1, in one embodiment of this invention the administrative tool 40 may be connected into a centralized cloud-based server, where router 52 also resides. This further enables a connection into trading gateway 60 through router 52. In all cases, an operative feature of this invention is the aggregation and management of leader and follower orders such that the sum total of those orders is placed in one single block order.

Once the leader places an order into the front-end trading application 10 or third-party software 30, the application therefore combines the leader and all follower orders and, via the router 52, places an order at the exchange, broker or dealer for the leader and its followers as a single order into a block account. The LF administrator tool 40 pairs the followers' orders with the leader's orders and stores this information in storage device 50. Once the order has been fully filled, the futures commission merchant or broker/dealer will accumulate all fills for both the leader and the followers, will calculate an average price for the fills, and will report this information back to the leader/follower system. The LF Administrative tool 40 then interacts with the data stored in storage device 50 to generate an audit trail and individual leader/follower fills.

In another embodiment of this invention, rather than the leader's utilizing third-party software that feeds order information into front-end trading application 10, as seen in FIG. 1 a leader trader may utilize third-party software 30 that feeds information directly into trading gateway 60 via pathway 16. As gateway 60 is connected to router 52 via pathway 55, in this alternate embodiment router 52 will receive information about the leader trader's orders from trading gateway 60 and, again via its proprietary logic, will aggregate that information with follower orders to direct execution and filling of a single block trade for the aggregated leader and follower orders.

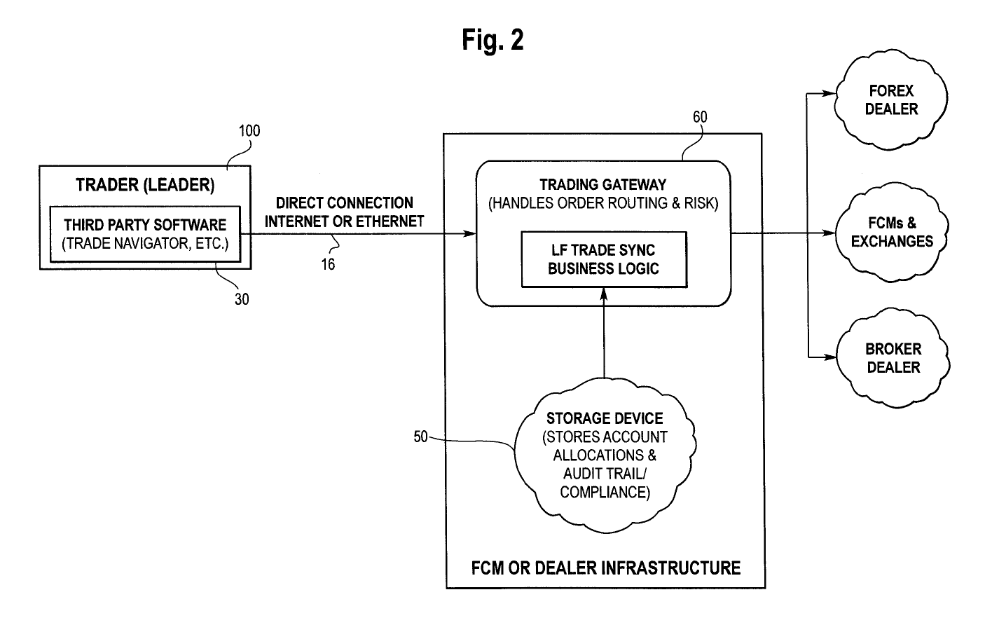

FIG. 2 depicts a more scaled down version of this alternative embodiment. As seen in FIG. 2, a leader trader 100 may use a third-party software 30 to place an order and communicate the order directly to a trading gateway 60. Communication between third-party software 30 and gateway 60 is enabled via an internet or ethernet connection 16. The trading gateway 60 can be modified with the same form or proprietary logic that is embodied in router 52 to communicate with the third-party trading application and to inform the trading application that the order has been placed. Persons skilled in the art will understand the code and interface necessary to facilitate this communication, and either proprietary code can be developed for this purpose, or any number of public-domain communications protocols may be utilized. This coding and interfacing will be developed such that it will then communicate with a storage device 50 that contains account allocations and audit trail information, which will then communicate the number of followers back to the trading application. The trading application will communicate this information to the trading gateway (again, via either a proprietary communications protocol, or public domain protocols) to combine the leader trader's order with the number of followers communicated from the database. The trading gateway will route the order to the dealer, broker, or exchange. As with other embodiments, in this embodiment proprietary logic is embedded within the trading order and execution pathways that causes follower orders to be aggregated with a leader order such that the combined leader and follower orders are placed and executed as s single block trade.

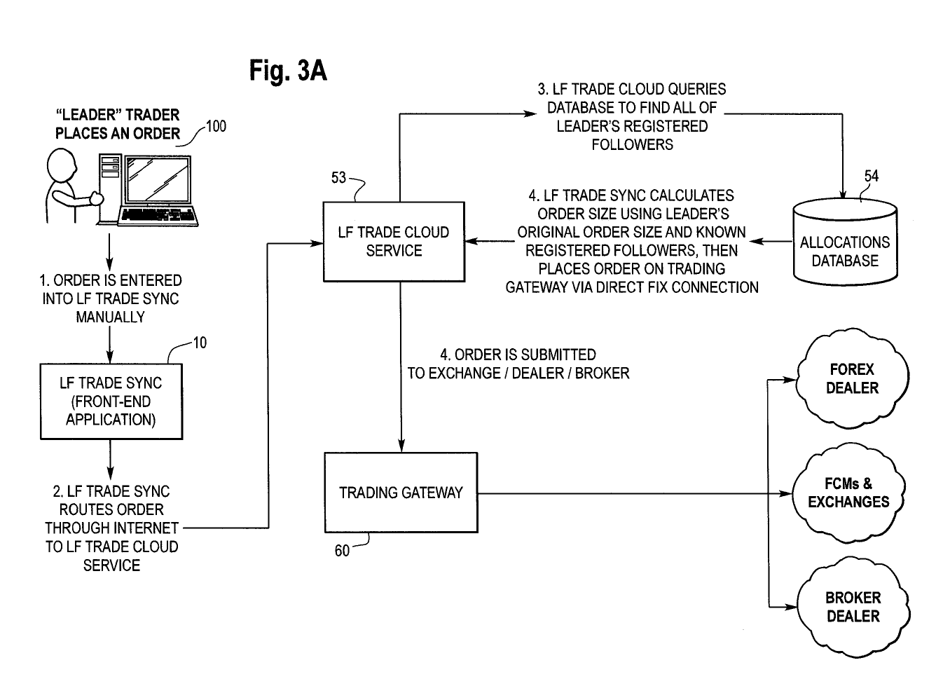

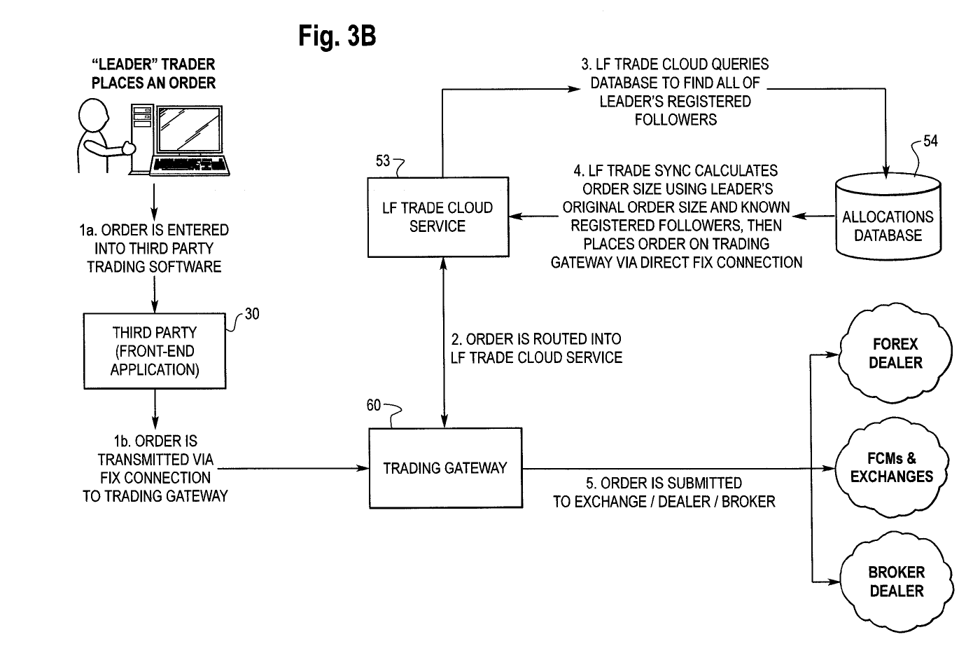

FIGS. 3a and 3b depict flowcharts, respectively, for embodiments of this invention for trades that a leader submits via a dedicated leader/follower front-end application and for trades that a leader submits using a third-party application. In each case, actual trade execution takes place between a trader and an exchange, dealer or broker. In FIG. 3a, the leader 100 places his or her order directly into a leader/follower front-end application 10. The front-end trading application 10 will then forward the order request of the leader into a centralized leader/follower service 53, which, in the embodiment shown in FIG. 3a, may be a centralized cloud-deployed database or some other dedicated database storage system, that stores allocation, audit trail information, and user related settings stored in one global location. The leader/follower service 53 works in conjunction with allocations database 54. Database 54 includes information for all followers who are registered with the leader/follower service to follow the trades of a particular lead trader. The proprietary logic embedded in the leader/follower service 53 aggregates the lead trader's original order with all follower orders to enable the placing of a single block order for the entire trade. The leader/follower front-end application 10 and service 53 will generally be configured to allow the creation and deletion of users for the leader/follower system, the ability to shut-off a user at any time, and the creation and configuration of leader/follower pairs. This dynamic configurability of the system allows an administrator to change the structure of leader/follower orders on a granular level, rather than requiring followers, for example, to participate in all trades that a lead trader may order.

The LF front-end trading application 10 communicates with leader/follower service 53 and a database 54 to identify the lead trader and the identities and the number of followers are associated with that leader. The system and method of the present invention then causes this aggregated information to be relayed back to the trader front-end trading application 10. Based on this configuration of the leader/follower pairs, the trader front-end application 10 registers the proper number of the underlying investment product to trade based on the leader's original order size and known registered followers. A single block order is initiated to the average price system exchange account at the trading gateway 60 that handles order routing and risk. This system and method will work with any investment product, including, without limitation, currencies, shares of stock, options, futures, or other similar products. The trading gateway routes the order to the dealer, broker, future commissions merchants, exchanges, or similar types of institutions or brokers based on the order requested.

The sequence of events is analogous when a lead trader submits an order via a third-party trading software application, as shown in FIG. 3b. With this configuration, the lead trader enters his or her trading order into third-party application 30, which transmits the order via a FIX pathway into trading gateway 60. The order is then routed, via the proprietary logic inherent in the system and methodology of this invention, into leader/follower service 53. Again, the leader/follower service 53 works in conjunction with allocations database 54, which includes information for all followers who are registered with the leader/follower service to follow the trades of a particular lead trader. The proprietary logic embedded in the leader/follower service 53 aggregates the lead trader's original order with all follower orders to enable the placing of a single block order for the entire trade.

It is apparent from the foregoing description that the system and method of the present invention are designed to work with leader and follower traders that are registered as such within the inner workings of the system and method. Individual follower traders who are not registered will not receive the benefits of the system as their follower orders are not included in the aggregated order information that is relayed back to the LF administrator. Although the system and methodology of the present invention is designed to work with systems in which a leader and several followers are all centrally registered, this system and methodology can further be utilized by single leaders who have yet to add followers, i.e. a leader can be registered into a system without any corresponding registered followers. The leader can register without followers, confirm to his or her satisfaction that the system and methodology works as it is intended to work, and then subsequently add and register followers into his trading strategies. Thus the system and method of this invention implicitly encourages follower traders to register within the system and method in order to gain the greatest possible benefit of the leader/follower trading patterns.

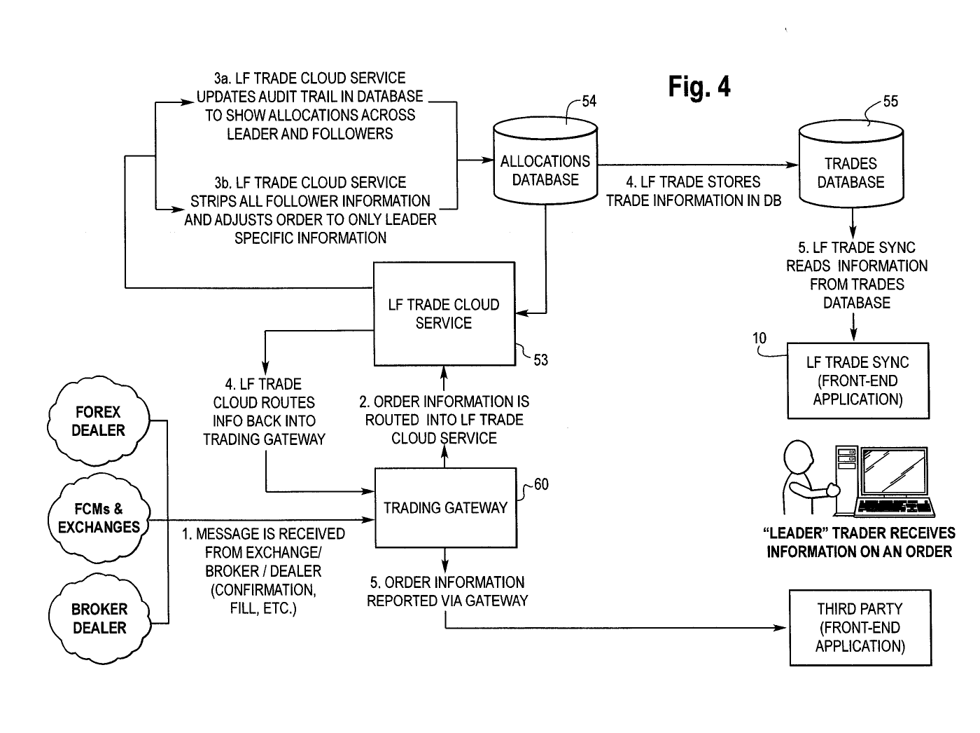

FIG. 4 depicts a flowchart for order fulfillment and trade execution between an exchange, a dealer or broker and the trader. As noted above, in the system and methodology of this invention, a lead trader places his or her order, that order is then aggregated with orders from followers who are registered with the leader/trader system, and the order is communicated to the relevant exchange to be filled as a single block order. Once the dealer, broker, or exchange fills the order, the allocation is communicated back to the trading gateway 60, which then routes this information back to the leader/follower service 53. The leader/follower service updates the audit trail by communicating with the database 54 to show allocations across the leader and followers. The leader/follower service 53 also strips all follower information and adjusts the order to only leader-specific information. The leader/follower service 53 also directs information about the trade to be stored in trades database 55. The leader/follower front-end application 10 receives and reads information from trades database 55, thus allowing the lead trader to verify that his or her trade has been executed and filled, and to confirm the price at which the trade order was filled. Where a third-party trading application is used, this information is fed directly to the third party application from trading gateway 60. In both cases, no information regarding the order(s) for any follower is communicated to the leader.

The advantages of the present invention include, without limitation, providing security of trading activity, streamlining trading activity, and avoiding any price slippage between leaders and followers in program trading systems for futures, forex, stocks, and options on any of the foregoing products. The system combines orders entered by the lead trader with the followers' block to create a single block. The block orders ensure execution for all members of the block at the same price. Split fills are averaged-priced to provide a single fill price for leader and followers alike. With this system, the leader and followers are unable to see each others' account information and order requests. In prior art trading systems, this information is normally exposed while in the trading gateway. The system and method of this invention facilitates this anonymity by stripping identifying information from the trade order before it is placed. That information is then merged back with information that is returned into the system from order fulfillment and execution.

The foregoing description of the drawings and aspects of the system and method of the present invention thus clarify the individual elements comprising the invention. Specifically, this system and method includes, first, a software system and method that a leader trader will utilize to initiate an order for an investment product. The trader can place the order directly via the use of a dedicated leader/follower trading application or with the front-end trading application that includes a component to create an interface between the trading software and a leader/follower application to record and track the leader's order. The system and method of this invention also includes a routing service, which may be a standalone router or some other means to control flow of information into and from a trading gateway. The routing service may be cloud-computing based, as may any data storage means that are accessed by both the front-end trading application and the leader/follower routing service. These data storage means may also be a dedicated storage array, or other means of data storage that will be known to persons skilled in the art. The front-end trading application for both the trader and the leader/follower routing service will connect to an investment product trading gateway, through which trades are placed, executed and confirmed. Prior to placement of a trade for execution, the leader/follower routing service will have received instructions from one or more followers for placing order for investment products in lockstep with the leader's trades. The leader/follower routing service accumulates and combines all orders for both the leader and the followers and causes the orders to be executed as a single block trade, which allows the orders of both the leader and all the followers to be filled at the same price. In the event that the single block trade cannot be filled in a single transaction, the leader/follower routing service will cause the order to be executed through a series of split-fills. Where the orders are filled through split-fills that are at different prices, the system and method of this invention averages the prices and causes the orders from the leader and followers to be filled at the same average price, in the form of a virtual single-block trade. The leader/follower routing service then de-aggregates all of the trades and reports them back to the leader and all of the followers without any identifying information being disclosed to any of the parties that participate in the system.

Persons skilled in the art will recognize that a component of this entire system and methodology will be the software which includes proprietary logic that accumulates and combines the leader's and the follower's orders to enable all of those orders to be executed as a block trade. That software will include, at a minimum, coding to interface with existing third-party trading platforms, such as Trade Navigator™; coding to facilitate storage of information in a manner that allows access to that information by both traders and leader/follower administrators; coding to synchronize multiple investment product order inputs, that are then aggregated and combined to facilitate placement of a plurality of orders as a single, block order; and coding to segregate the single block trade back into individual trading accounts to assure compliance with regulatory and record-keeping requirements without any disclosure of identifying information to the leader and follower participants in the system. As will be obvious, the foregoing system executes the block trade in a single transaction or in a series of transactions that are near-instantaneous such that the price differentials that are otherwise inherent in leader and follower trading strategies are minimized or eliminated.

The coding logic, functional specifications and data flow of the foregoing software will vary from system to system, and no specific code is disclosed as part of this invention. Persons skilled in the art of investment product trading applications will be well aware of the requirements of this code, and will develop the code accordingly.

The invention disclosed herein also includes a multi-component machine or apparatus for executing the method and system described herein. The components of the machine will include, at a minimum, a first hardware computing platform that a leader trader will utilize to initiate a trade order; a second hardware computing platform that the leader/follower routing service utilizes to manage the system and methodology of the foregoing invention; data storage means to record orders for trades and the execution of those orders; and computing means that accumulate and combine a leader's trading orders with a plurality of follower orders such that the total orders can be executed as a single block trade, that compute average pricing in the event that the block trade is filled with split-fills, and that de-aggregate and report information regarding the trade back to the leader/follower routing service in a format that separate the leader trade and all of the follower trades. The foregoing hardware computing platforms, data storage means and computing means can be any of a number of commercially available products, including, for example, laptop or tablet computers, and it is not the intention of the inventors to limit this invention to any specific hardware.

### Example of a Transaction According to the Present Invention

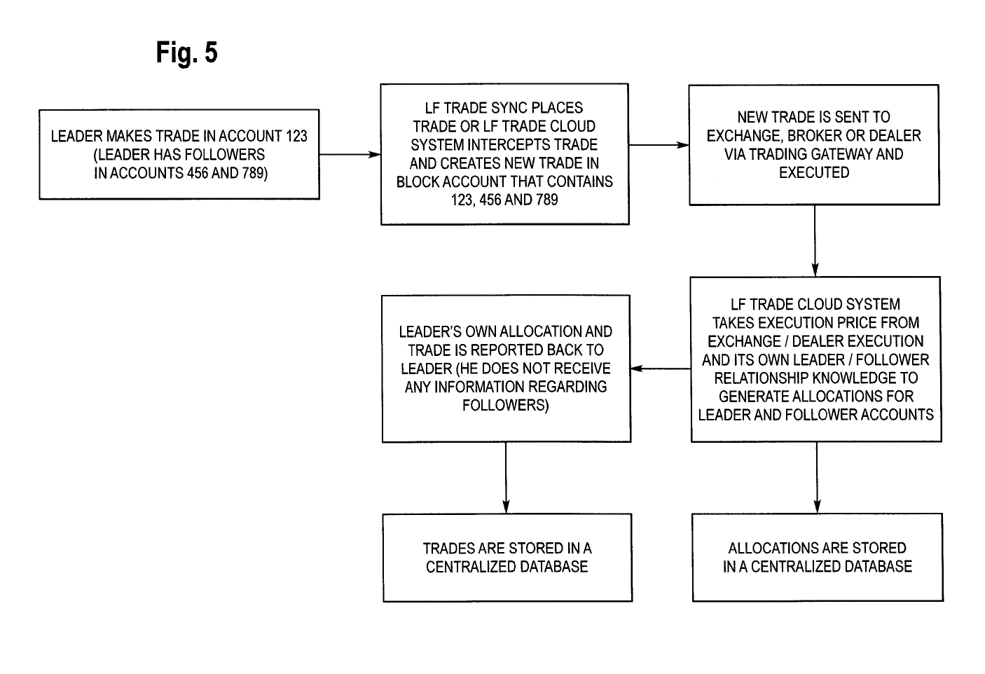

FIG. 5 depicts an example of a transaction being processed according to the present invention. For example, assume that a group of followers want to perform the exact same trades as a lead trader. The followers will register with the system to indicate their preferences for following the leader's trades. The lead trader accesses the trader version of the front-end application to place an order to buy one lot of a specified futures contract. The front-end application will communicate with the leader/follower routing service, which intercepts the lead trader's trade and aggregates it with the follower's trade orders to create a single new block trade. Although not shown on FIG. 5, this information will be recorded for tracking and audit purposes in a database. For this example, assume that the lead trader places an order to buy 3 E-mini S&P contracts in the block account via the FCM/dealer FIX connection. Assume further that if these orders were executed and filled separately, the lead trader's order might be filled at $1,400.75 and the followers' orders might be filled at $1,400.00. The system and this invention will aggregate all of these orders and cause them to be filled at an average of $1,400.25. Alternately, if all of the orders could not be filled as a single order, the system would fill them at a range of prices within a narrow band and then report back the same average price for all trades. When the exchange reports the fills, the front-end application will report that tall orders have been filled as a single trade at one average. The system and method also maintains an audit trail, which is accessible by the administrator of the front-end application, and which includes information that all lots have been allocated with account information and average price information.

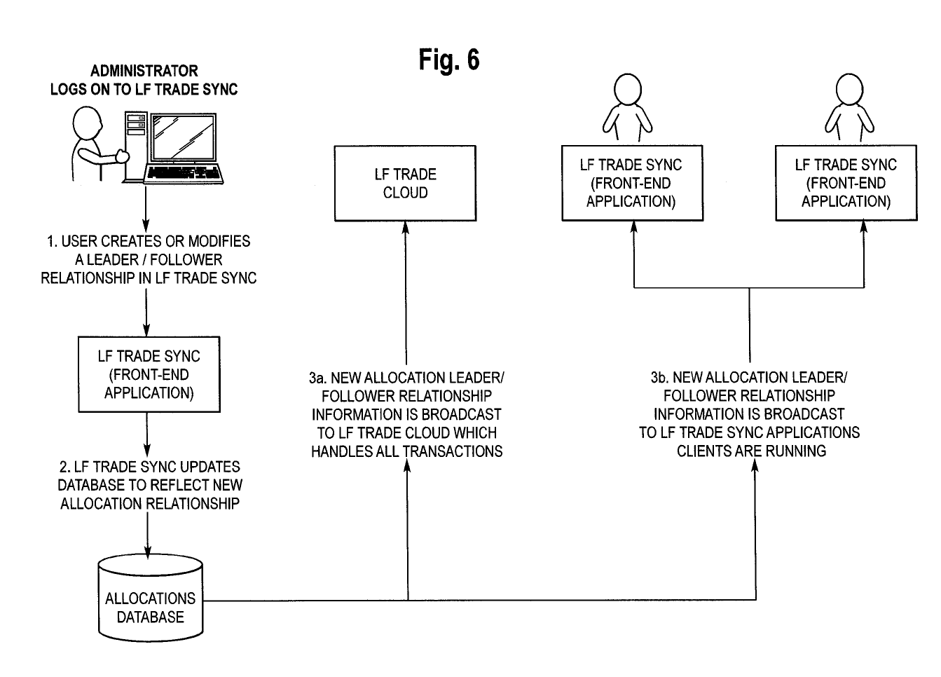

As depicted in FIG. 6, the system then reports the pricing and allocation back to the lead trader, but it reports no information regarding any of the followers. Similarly, the system reports pricing and allocation back to the followers, but does not give the followers any notification regarding any other follower or the leader. With this strategy, the followers place the exact same order as the leader but experience no price slippage. If this same scenario were to occur without this system, the leader would have his trade at $1,400.75 and the followers would have their trades at $1,400.00. With this new system, the leaders and followers are allocated the average price of $1,400.25.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples used herein. The invention should therefore not be limited by the above described embodiment, method, and examples, but by all embodiments and methods within the scope and spirit of the invention.

1. A system and method for the simultaneous average price execution of trades in leader and follower trading accounts, said system and method comprising:
Data input means to facilitate a lead trader's input of one or more orders for financial products;
Storage and recording means for follower traders to register and record preferences for trading orders that follow said lead trader's orders;
Order routing means that are configured to aggregate said lead trader's orders and said follower traders' preferences prior to forwarding said lead trader's order to a trading gateway for fulfillment and execution, said order routing means being further configured to segregate and store identifying information about the lead trader and the follower traders from said aggregated order, and to re-integrate said identifying information following execution and fulfillment of trades;
One or more data interfaces between said routing means and a financial products trading gateway; and
One or more data storage means to store and record all information with respect to trades implemented via said system and method.

2. The system and method of claim 1 wherein said data input means is an independent trade order and execution product, and including interface means for communication between said product, said order routing means and said trading gateway.

3. The system and method of claim 1, wherein said routing means comprises one or more software routines that are stored and implemented via a cloud-based computing environment.

4. The system and method of claim 1, wherein said lead trader's trading order and said followers' trading orders are aggregated such that they are filled and executed as a single block trade.

5. The system and method of claim 1, including further means to determine and acknowledge aggregated trades that may not be amenable to fulfillment and execution as a single block trade and to direct that such trades be placed in a series of trades, wherein the price of said series of trades is averaged and reported back to said routing means as a single average price for the entire aggregated trade.

6. The system and method of claim 1, including one or more interfaces between said trading gateway and financial products broker/dealers.

7. The system and method of claim 1, wherein said data storage means are configured to store and record trading information in a form and manner required to comply with regulatory reporting requirements in financial products trading environments.

8. A machine and computing apparatus for verifying and confirming that a plurality of leader trader and follower trader orders for financial products are filled and executed at the same average price, including:
one or more data entry systems by which a lead trader enter one or more orders for financial products;
one or more data storage systems or devices coupled with one or more data entry systems by which follower traders register and record preferences for trading orders that follow said lead trader's orders;
one or more data router processing units that are encoded to aggregate said lead trader's orders and said follower traders' preferences prior to forwarding said aggregated order to a trading gateway for fulfillment and execution, and to segregate and store identifying information about the lead trader and the follower traders from said aggregated order prior to placing said order and to re-integrate said identifying information following execution and fulfillment of trades;
one or more data interfaces between said router processing unit and a financial products trading gateway; and
one or more data storage systems to store and record all information with respect to trades.
